(19) United States
(12) Patent Application Publication
(10) Pub. No.: US 2003/0035857 A1
(43) Pub. Date: Feb. 20, 2003

(54) Process for preparing wheat bread and dough mix for same

(76) Inventor: Pongpun Elisa Sroka, Auburn, NY (US)

Correspondence Address: EDWARD A. HEDMAN, HEDMAN & COSTIGAN, P.C., Suite 2003, 1185 Avenue of the Americas, New York, NY, 10036-2646, US

(21) Appl. No.: 10/105,073

(22) Filed: Mar. 21, 2002

Related U.S. Application Data
(60) Provisional application No. 60/284,046, filed on Apr. 16, 2001.
(60) Provisional application No. 60/277,858, filed on Mar. 22, 2001.

(51) Int. Cl. A21D 2/00

(52) U.S. Cl. 426/19

(57) ABSTRACT

A whole wheat bread loaf made simply and rapidly from a dough consisting essentially of flour, salt, and active yeast and warm water. The breads of the invention contain no milk, eggs, butter, or sucrose sugars. If the yeast is of the rapid rise dry yeast type, one of the punch down steps can advantageously be omitted.

### CROSS REFERENCE TO RELATED APPLICATIONS

The present application claims the benefit of U.S. Provisional Patent Application No. 60/284,046, filed Apr. 16, 2001 and U.S. Provisional Patent Application No. 60/277,858, filed Mar. 22, 2001.

### FIELD OF THE INVENTION

This invention relates to a system of process steps and mixes of ingredients for improving the making of bread on a small or large basis. More particularly the bread is baked from dough mixes stiff enough to knead or roll yet containing fewer ingredients than those classically employed, in different quantities and with fewer steps.

### BACKGROUND OF THE INVENTION

The numerous kinds of breads that homemakers, retail stores and commercial bakers, and the like offer to family members and/or customers who consume and/or purchase their products is a matter of common knowledge and experience.

As to the ingredients, it is common to employ, in addition to flour, water, salt and yeast, the following additional ingredients: butter, margarine or another source of oil, cane or beet sugar, sometimes eggs, and, especially milk. By way of illustrating such ingredients, incorporated herein by reference is a five page syllabus passed out to attendees of the Cornell University Cooperative Extension Class on Bread-Making, at least as early as September, 1982, (the “Cornell Syllabus”). The Cornell Syllabus teaches on the second physical page thereof a recipe for “HONEY WHEAT BREAD”, made from all-purpose flour, whole wheat flour, water, salt, yeast, honey, and the following additional ingredients: dry powder milk and oil, in specified amounts. On the fourth physical page of the Cornell Syllabus a recipe for “ENRICHED WHITE BREAD” calls for flour, salt, yeast, water and the following additional ingredients: sugar, margarine, and milk. In either case, if such additional ingredients could be eliminated from the bread, it would be especially appealing to the health conscious, and particularly those who must avoid fats, especially butter, watch their cane or beet sugar (sucrose) intake, and carefully control the ingestion of milk products because of their milk sugar (lactose) content.

It is therefore desirable to provide compositions which are free from such additional ingredients, yet have equivalent or superior taste. This is a principal object of the present invention.

As to the bread-making process steps, it is well known that bread of high quality is difficult to produce without attention to baking temperature, handling of the dough, size of the loaf pan, freshness of the yeast, quality of the flour, the time of rising of the dough, evenness of heat in the oven, and even the amount of fermentation, and the like. To exemplify the complexity of the method, the “Enriched White Bread” of page four of the Cornell Syllabus requires no less than 13 steps, including scalding the milk, and refrigerating the dough for 2-24 hours; and the “Honey Wheat Bread” on page two of the Cornell Syllabus requires at least 17 steps, and a plastic bag, as set fourth on page one.

Because so many process steps are involved it is obvious that simplification is desired to avoid producing bread of inferior quality. Reducing the number of steps and elapsed time are other principal objects of the present invention.

By way of showing such process/quality relationships, reference is further made to the second physical page of the Cornell Syllabus which teaches that the causes of inferior bread are as follows: poorly shaped loaves are due to inexperience in handling, dough too stiff or not stiff enough, oven not hot enough or heat uneven, too much dough for the pan; coarse grain is due to the oven temperature being too low, and too much rising before baking; streaks are due to allowing the top of the dough to dry during the rising period, uneven mixing or kneading, dry flour folded into loaves during shaping, dough too heavily greased on top during rising; crust splitting in top or sides is due to the oven being too hot in the beginning or the dough being too stiff; soggy or heavy bread is due to insufficient rising or baking, low quality of flour or yeast; thick cell walls are due to too little fermentation, kneading the dough too hard before shaping, low quality of flour; off-flavor is due to old yeast, too long rising of dough, too high temperature during rising, too slow or incomplete baking, or insufficient scalding of milk.

Also relevant to show the state of the art is Spanier et al., U.S. Pat. No. 4,604,289 who describe a quick acting whole wheat bread mix for home use and a process for preparing uniform symmetrical loaves. The essentials of the whole wheat dry mix are a fine grain flour, vital gluten and a carbohydrate mixture of dextrose and sucrose in the proper proportions. The process requires a special shaping such as the lamination technique, which is also applicable to breads other than whole wheat.

It is noteworthy that the '289 patent requires a mixture of sugars, sucrose and dextrose, added gluten, preferably added dry milk solids, and a special shaping step, even though less than 2 hours from adding water to the dry mix is sufficient to complete baking.

Thus a providing a simplified dough mix and a process with fewer steps would help produce bread of excellent quality.

This is a further object of the present invention.

### SUMMARY OF THE INVENTION

The above-mentioned objects and advantages are achieved in accordance with the present invention by providing a dough by the steps comprising:

a. mixing a composition consisting essentially of flour, salt and yeast in a container;

b. adding warm water to produce a dough mix and beating the dough mix until the dough pulls away from the sides of the vessel;

c. placing the dough mix in a warm place, covering it and allowing it to rise until double in bulk;

d. punching the dough down reduce its bulk;

e. rolling out the punched down dough;

f. shaping the rolled-out, punched-down dough to fit a loaf-sized container and placing the shaped dough a loaf-sized baking container; and

g. baking the shaped dough at a suitable temperature and for a length of time sufficient to provide a loaf of bread that contains no milk, butter, eggs or sucrose-based sugar.

Among the preferred embodiments of the present invention are using as flour, wheat flour, white bread flour, more preferably, unbleached flour, and, especially preferably, bromate free enriched unbleached flour. Special mention is made of whole wheat flour, preferably a stone ground, unbromated, unbleached whole wheat flour, made from the whole kernel, including the whole germ.

Also preferred for use as substitutes for sucrose sugar, are honey and/or molasses, or an obvious chemical equivalent. Preferred for use as yeast is active dried yeast, especially rapidrise yeast. It is preferred to add warm water in step (b). heated to 115-120° F. Preferred baking temperatures are 350-375° F. and baking times of 20, 30, 45 and 50 minutes.

The basic ingredients can be modified without departing from the invention, as will be shown in the examples by using whole wheat flour exclusively and water and honey to produce Honey Whole Wheat Bread; by using white bread flour exclusively and water and honey and adding cinnamon to produce Cinnamon Bread; by using a mixture of white bread flour and rye flour and water and honey and adding caraway seeds to produce Rye Bread; by using a mixture of stone ground whole wheat flour and water and molasses and adding walnuts, raisins and cinnamon to produce Cinnamon Raisin Walnut Bread; by using a mixture of stone ground whole wheat flour and white bread flour and water and honey and adding cheddar cheese and chopped garlic to produce a Garlic Cheddar Bread, and by using white bread flour exclusively and water and honey to produce White Bread.

### DESCRIPTION OF THE PREFERRED EMBODIMENTS

The following Examples illustrate the dough mixes prepared by the processes of the present invention and their use in producing the baked bread products. The invention is not limited to the specific examples.

### EXAMPLE 1

### Honey Whole Wheat Bread

| | | |
|---|---|---|
| Dough Mix. | 3 | cups of stone ground whole wheat flour |
| | 1¼ | tsp salt |
| | 1 | pkg active dried yeast (¼ oz) |
| | 1 | cup warm water (115-120° F.) |
| | 4 | tbsp honey |

Process.

In a mixing vessel, combine 1½ cups flour, salt and yeast. Heat water and honey until very warm (115-120° F.). Stir into dry ingredients; add remaining flour to make soft dough. Beat with an electric beater until dough pulls away from sides of vessel. Continue beating for 3-4 minutes longer. Place dough in a greased vessel, cover, and let rise in a warm, draft-free place until doubled in bulk (about 50 minutes). Punch dough down. Shape dough into a ball. Place dough in a greased baking dish, 8″ diameter×4½″ deep. cover and let rise in a warm, draft-free place until doubled in size (about 40 minutes). Bake at 375° F. for 45-50 minutes or until done. Remove from oven and let cool on a wire rack.

This loaf of bread contains no milk, butter, eggs or sucrose sugar.

### EXAMPLE 2

### Honey Whole Wheat Bread

| | | |
|---|---|---|
| Dough Mix. | 2½ | cups of stone ground whole wheat flour |
| | 1 | cup unbleached unbromated white bread flour |
| | 1¼ | tsp salt |
| | 1 | pkg rapidrise yeast (¼ oz) |
| | 1½ | cups warm water (120-130° F.) |
| | 2½ | tbsp honey |

Process.

Combine 1½ cups whole wheat, white flour, salt and yeast in a mixing vessel. Heat water and honey until very warm (120-130° F.); stir into dry ingredients; add remaining flour to make soft dough. Beat with an electric beater until dough pulls away from sides of vessel. Continue beating for 3-4 minutes longer. Cover, and let rest on a floured surface for 10 minutes. Knead dough for 4-5 minutes until it is soft and elastic. Shape dough into a ball. Place dough in a greased baking pan, 8″ diameter×4½″ deep. Cover and let rise in a warm, draft-free place until doubled in size (about 40 minutes). Bake in a preheated oven at 375° F. for 45-50 minutes or until done. Remove from oven and let cool on a wire rack.

This loaf of bread contains no milk, butter, eggs or sucrose sugar.

### EXAMPLE 3

### Cinnamon Swirl Bread

| | | |
|---|---|---|
| Dough Mix. | 3 | cups unbleached, unbromated white bread flour |
| | 1½ | tsp salt |
| | 1 | pkg active dried yeast (¼ oz) |
| | 1⅓ | cups warm water (115-120° F.) |
| | 4 | tbsp honey |
| | 4 | tbsp of ground cinnamon |

Process.

Combine 1½ cups flour, salt and yeast in a mixing vessel. Heat water and 3 tablespoons of honey (reserve 1 tbsp) until very warm (115-120° F.). Stir into dry ingredients. Add remaining flour to make soft dough. Beat with an electric beater until dough pulls away from sides of vessel. Continue beating for 3-4 minutes longer. Place dough in a vessel, cover, and let rise in a warm, draft-free place until doubled in bulk (about 50 minutes). Punch dough down. Heat remaining 1 tablespoon of honey until slightly warm, add cinnamon, mix well. Roll dough out into a 12″×7″ rectangle. Spread cinnamon mixture of rolled out dough. Beginning from short end, roll up jelly roll style. Pinch seams and ends to seal. Shape dough into a ball. Place dough in a greased baking dish, 8″ diameter×4½″ deep. Cover and let rise in a warm, draft-free place until doubled in size (about 40 minutes). Bake at 375° F. in a preheated oven for 45-50 minutes, or until done. Remove from oven and let cool on a wire rack.

This loaf of bread contains no milk, butter, eggs or sucrose sugar.

### EXAMPLE 4

### Cinnamon Swirl Bread

| Dough Mix. | 3½ | cups unbleached, unbromated white bread flour |
|---|---|---|
| | 1½ | tsp salt |
| | 1 | pkg rapidrise dried yeast (¼ oz) |
| | 1½ | cups warm water (120-130° F.) |
| | 4 | tbsp honey |
| | 3 | tbsp of ground cinnamon |

Process.

Combine 1½ cups flour, salt and yeast in a mixing vessel. Heat water and 3 tablespoons of honey (reserve 1 tbsp) until very warm (120-130° F.). Stir in dry ingredients. Add remaining flour to make soft dough. Beat with an electric beater until dough pulls away from sides of vessel. Continue beating for 3-4 minutes longer. Place dough on a floured surface, cover and let rest for 10 minutes longer. Knead dough 3-4 minutes. Mix the reserved honey (1 tablespoon) and cinnamon. Roll dough out into a 12″×7″ rectangle. Spread cinnamon-honey mixture evenly on the rolled out dough. Beginning from short end, roll up jelly roll style. Pinch seams and ends to seal. Shape dough into a ball. Place dough in a greased round baking dish, 8″ diameter×4½″ deep. Cover and let rise in a warm, draft-free place until doubled in size (about 40 minutes). Bake at 375° F. in a preheated oven for 45-50 minutes, or until done. Remove from oven and let cool on a wire rack.

This loaf of bread contains no milk, butter, eggs or sucrose sugar.

### EXAMPLE 5

### Rye Bread

| | | |
|---|---|---|
| Dough Mix. | 1 | cup unbleached, unbromated white bread flour |
| | 2 | cups Rye flour |
| | 2 | tbsp caraway seeds |
| | 1½ | tsp salt |
| | 1 | pkg active dried yeast (¼ oz) |
| | 1 | cup warm water (115-120° F.) |
| | 2 | tbsp honey |

Process.

In a mixing vessel, combine white flour, Rye flour, reserving a small but effective amount for later use, caraway seeds, salt and yeast. Heat water and honey until very warm (115-120° F.). Stir into dry ingredients; add remaining flour to make soft dough. Beat with an electric beater until dough pulls away from sides of vessel. Continue beating for 3-4 minutes longer. Place dough in a greased vessel, cover, and let rise in a warm, draft-free place until doubled in bulk (about 50 minutes). Punch dough down. Shape dough into a ball. Place dough in a greased baking dish, 8″ diameter×4½″ deep. cover and let rise in a warm, draft-free place until doubled in size (about 40 minutes). Bake in a preheated oven at 375° F. for 45-50 minutes. Remove from oven and let cool on a wire rack.

This loaf of bread contains no milk, butter, eggs or sucrose sugar.

### EXAMPLE 6

### Rye Bread

| | | |
|---|---|---|
| Dough Mix. | 2½ | cups unbleached, unbromated white bread flour |
| | 1 | cup Rye flour |
| | 1 | tbsp caraway seeds |
| | 1½ | tsp salt |
| | 1 | pkg rapidrise dried yeast (¼ oz) |
| | 1½ | cups warm water (120-130° F.) |
| | 1½ | tbsp honey |

Process.

Combine 1½ cups white flour, Rye flour, caraway seeds, salt and yeast in a mixing vessel. Heat water and honey until very warm (120-130° F.); stir in dry ingredients; add remaining flour to make soft dough. Beat with an electric beater until dough pulls away from sides of vessel. Continue beating for 3-4 minutes longer. Cover, and let rest on a floured surface for 10 minutes. Knead dough for 4-5 minutes until it is soft and elastic. Shape dough into a ball. Place dough in a greased baking pan, 8″ diameter×4½″ deep. Cover and let rise in a warm, draft-free place until doubled in size (about 40 minutes). Bake in a preheated oven at 375° F. for 45-50 minutes or until done. Remove from oven and let cool on a wire rack.

This loaf of bread contains no milk, butter, eggs or sucrose sugar.

### EXAMPLE 7

### Cinnamon-Raisin-Walnut Bread

| | | |
|---|---|---|
| Dough Mix. | 2 | cups unbleached, unbromated whitebread flour |
| | 1 | cup stone ground whole wheat flour |
| | 1½ | tsp salt |
| | 4 | tbsp cinnamon |
| | 1 | pkg active dried yeast (¼ oz) |
| | 1 | cup very warm water (115-120° F.) |
| | 4 | tbsp molasses |
| | ½ | cup walnuts |
| | ½ | cup raisins |

Process.

In a mixing vessel, combine 1½ cup white flour, whole wheat flour, salt cinnamon and yeast. Heat water and molasses until very warm (115-120° F.). Stir in dry ingredients; add remaining flour to make soft dough. Beat with an electric mixer until dough pulls away from sides of vessel. Continue beating for 3-4 minutes longer. Place dough in a greased vessel, cover, and let rise in a warm, draft-free place until doubled in bulk (about 50 minutes). Punch dough down. Knead in walnuts and raisins. Shape dough into a ball. Place dough in a greased round baking dish, 8″ diameter×4½″ deep. Cover and let rise in a warm, draft-free place until doubled in size (about 40 minutes). Bake in a preheated oven at 375° F. for 45-50 minutes. Remove from oven and let cool on a wire rack.

This loaf of bread contains no milk, butter, eggs or sucrose sugar.

### EXAMPLE 8

### Cinnamon-Raisin-Walnut Bread

| | | |
|---|---|---|
| Dough Mix. | 2½ | cups unbleached, unbromated white |
| | | bread flour |
| | 1 | cup stone ground whole wheat flour |
| | 1½ | tsp salt |
| | 3 | tbsp cinnamon |
| | 1 | pkg rapidrise dried yeast (¼ oz) |
| | 1½ | cups very warm water 120-130° F.) |
| | 2 | tbsp molasses |
| | 3 | tbsp honey |
| | ½ | cup raisins |
| | ½ | cup walnuts |

Process.

Combine 1½ cups white and wheat flour, salt, cinnamon and yeast in a mixing vessel. Heat water, molasses and honey until very warm (120-130° F.); stir in dry ingredients; add remaining flour to make soft dough. Beat with an electric mixer until dough pulls away from sides of vessel. Continue beating for 3-4 minutes longer. Cover, and let rest on a floured surface for 10 minutes. Knead in raisins and walnuts. Knead dough for 4-5 minutes until it is soft and elastic. Shape dough into a ball. Place dough in a greased baking dish, 8″ diameter×4½″ deep. Cover and let rise in a warm, draft-free place until doubled in size (about 40 minutes). Bake in s preheated oven at 375° F. for 45-50 minutes or until done. Remove from oven and let cool on a wire rack.

This loaf of bread contains no milk, butter, eggs or sucrose sugar.

### EXAMPLE 9

### Garlic-Cheddar Bread

Dough Mix.

2 cups stone ground whole wheat flour

1 cup unbleached, unbromated white bread flour

1½ tsp salt

1 pkg. active dried yeast

1 cup warm water (115-120° F.)

1 tbsp honey

2 clove garlic, minced

3 oz sharp cheddar cheese, cut in ½″ thick, 1 ″ long

Process.

Combine 1½ cups of whole wheat, white flour, salt and yeast in a mixing vessel. Heat water and honey until very warm (115-120° F.), add garlic; stir in dry ingredients. Add remaining flour to make soft dough. Beat with an electric mixer until dough pulls away from the vessel, about 3-4 minutes. Knead in cheese. Place dough in a greased vessel, cover and let rise in a warm, draft-free place until doubled in size, about 50 minutes. Punch dough down; shape into a ball. Place in a greased round baking dish (8″ diameter×4½″ deep). Cover, let rise in warm draft-free place until doubled in bulk about 40 minutes. Bake in a preheated oven at 375° F. for 45-50 minutes or until done. Remove from oven. Cool on wire rack.

This loaf of bread contains no milk, butter, eggs or sucrose sugar.

### EXAMPLE 10

### Garlic-Cheddar Bread

| Dough Mix | 1½ | cups stone ground whole wheat flour |
|---|---|---|
| | 2 | cups unbleached, unbromated white bread flour |
| | 1½ | tsp salt |
| | 1 | pkg rapidrise dried yeast |
| | 1½ | cups warm water (120-130° F.) |
| | 1½ | tbsp honey |
| | 2 | tsp garlic, minced |
| | 3 | oz sharp cheddar cheese, cut into 1″ chunks |

Process.

Combine 1½ cups whole wheat flour, white flour, salt and yeast in a mixing vessel. Heat water and honey until very warm (120-130° F.); stir in dry ingredients. Add garlic, mix well. Beat with an electric beater until dough pulls away from the sides of vessel, continue beating 3-4 minutes longer. Cover, let rest on floured surface, 10 minutes. Knead in cheese, keep kneading 4-5 minutes. Shape into a ball. Place dough in a greased round baking dish (8″ diameter×4½″ deep). Let rise in a warm, draft-free place until double in size, about 40 minutes. Bake at 375 degrees F. for 45-50 minutes or until done. Remove from oven. Cool on rack.

This loaf of bread contains no milk, butter, eggs or sucrose sugar.

### EXAMPLE 11

### Honey White Bread

| Dough Mix. | 3¼ | cups unbleached, unbromated white bread flour |
|---|---|---|
| | 1½ | tsp salt |
| | 1 | pkg active dried yeast (¼ oz) |
| | 1 | cup warm water (115-120° F.) |
| | 2 | tbsp honey |

Process.

Combine flour, reserving a small but effective amount for later use, salt and yeast in a mixing vessel. Heat water and honey until very warm (115-120° F.); stir in dry ingredients. Add remaining flour to make soft dough. Beat with an electric mixer until dough pulls away from sides of vessel. Continue beating 3-4 minutes longer. Place dough in a greased vessel, turning to grease top. Cover, let rise in a warm, draft-free place until doubled in size about 40 minutes. Punch dough down. Place in a greased round baking dish (8″ diameter×4½″ deep). Cover, let rise in warm, draft free place until doubled in size about 40 minutes. Bake in a preheated oven at 375° F. for 45-50 minutes or until done. Remove from oven. Cool on rack.

This loaf of bread contains no milk, butter, eggs or sucrose sugar.

### EXAMPLE 12

### Honey White Bread

| Dough Mix | 3½ | cups unbleached, unbromated white bread flour |
|---|---|---|
| | 1¼ | tsp salt |
| | 1 | pkg rapidrise dried yeast (¼ oz) |
| | 1½ | cups warm water (120-130° F.) |
| | 2 | tbsp honey |

Process.

Combine 1½ cups flour, salt and yeast in a mixing vessel. Heat water and honey until very warm (120-130° F.); stir in dry ingredients. Add remaining flour to make a soft dough. Beat with an electric beater until dough pulls away from sides of vessel. Continue beating for 3-4 minutes longer. Cover and let rest on floured surface for 10 minutes. Knead dough 4-5 minutes and shape into a ball. Place dough in a greased round baking dish (8″ diameter×4½″ deep). Cover, let rise in a warm draft free place until doubled in size, about 40 minutes. Bake in a preheated oven at 375° F. for 45-50 minutes or until done. Remove for oven and cool on wire rack.

This loaf of bread contains no milk, butter, eggs or sucrose sugar.

### EXAMPLE 13

### Craisins/Orange Bread

| | | |
|---|---|---|
| Dough Mix | 2½ | cups unbleached, unbromated white bread flour |
| | 1 | cup stone ground whole wheat flour |
| | 1¼ | tsp salt |
| | 1 | pkg rapidrise dried yeast |
| | 1½ | cups warm water (120-130° F.) |
| | 3 | tbsp honey |
| | 1½ | tbsp orange zest |
| | ½ | cup of craisins |

Process.

Combine 1½ cups white, whole wheat flour, salt and yeast in a mixing vessel. Heat water and honey until very warm (120 130° F.). Stir in dry ingredients. Add orange zest and remaining flour to make a soft dough. Beat with an electric mixer until dough pulls away from the sides of vessel. Continue beating 3-4 minutes longer. Cover, let rest on floured surface, 10 minutes. Knead in craisins, keep kneading until dough is soft and elastic, 4-5 minutes. Shape into a ball. Place dough in a greased round baking dish (8″ diameter×4½″ deep). Cover, let rise in a warm, draft-free place until double in size, about 45-50 minutes. Bake at 375 degrees F. for 45-50 minutes or until done. Remove from oven. Cool on rack.

This loaf of bread contains no milk, butter, eggs or sucrose sugar.

The above-identified publication(s) and patent(s) are incorporated herein by reference.

Many variations of the instant invention will suggest themselves to those skilled in this art. For example, as will be obvious to those of ordinary skill in the art, the flour can be added all at once instead of in two steps; the amounts of the ingredients can be adjusted as well as the mixing temperatures, the rising temperatures, the baking temperatures and respective times. Furthermore, additives, such as dried cherries and dried blueberries can be added to the white bread dough of the invention to impart a patriotic coloration to the baked product. All obvious variations are within the full intended scope of the invention.

We claim:

1. A process for making at least one loaf of bread, without milk, butter, eggs or sucrose sugar said process comprising the steps of:
(a) combining, in a mixing vessel, flour, salt and active yeast;
(b) stirring very warm water, preferably between 115-120° F., into dry ingredients and optionally adding remaining flour to make soft dough;
(c) beating the dough until dough pulls away from sides of vessel and then continuing beating for a few, preferably 3-4, minutes longer;
(d) placing the dough in a greased vessel, covering, and letting rise in a warm, draft-free place for about an hour, preferably 40 to 60 minutes, more preferably 50 minutes, or until doubled in bulk;
(e) punching the dough down;
(f) shaping the dough into a ball;
(g) placing the dough in a greased baking dish, preferably, 8″ diameter×4½″ deep;
(h) covering and letting rise in a warm, draft-free place for less than an hour, preferably between 30 to 50 minutes, more preferably 40 minutes or until doubled in size;
(i) oven baking, preferably at 375° F., until done, preferably between 45-50 minutes; and
(j) removing the bread from the oven and letting cool.

2. A loaf of honey whole wheat bread prepared by the process of claim 1 wherein the flour comprises 3 cups of stone ground whole wheat flour, with 1½ cups added in step (a) and 1½ cups added in step (b); the amount of salt is 1¼ tsp.; the amount of active dried yeast is ¼ oz; and the amount of water is 1 cup with 4 tbsp. of honey added.

3. A loaf of cinnamon swirl bread prepared by the process of claim 1 wherein the flour comprises 3 cups of unbleached, unbromated white bread flour, with 1½ cups added in step (a) and 1½ cups added in step (b); the amount of salt is 1½ tsp.; the amount of active dried yeast is ¼ oz; the amount of water is 1⅓ cups with 3 tbsp. of honey added; the process also including the additional steps: after step (e) and prior to step (f),
(e¹) heating 1 tbsp of honey until warm and adding 4 tbsp of ground cinnamon to the honey and mixing well;
(e²) rolling the dough out into a rectangle, preferably 12″×7″;
(e³) spreading the honey—cinnamon mixture out evenly on the rolled out dough; then,
(e⁴) beginning at the short end, rolling up the dough, jelly-roll style, and
(e⁵) pinching all seams and ends to seal.

4. A loaf of rye bread prepared by the process of claim 1 wherein the flour comprises 1 cup of unbleached unbromated white bread flour and 2 cups of rye flour; with 2 tbsp. of caraway seeds added in step (a); the amount of salt is 1½ tsp.; the amount of active dried yeast is ¼ oz; and the amount of water is 1 cup with 2 tbsp. of honey added.

5. A loaf of cinnamon raisin walnut bread prepared by the process of claim 1 wherein the flour comprises 2 cups of unbleached unbromated white bread flour and 1 cup of stone ground whole wheat flour, with 1½ cups of unbleached unbromated white bread flour and 1 cup of stone ground whole wheat flour added in step (a) and 1 cup of unbleached unbromated white bread flour added in step (b); with 4 tbsp. of cinnamon added in step (a); the amount of salt is 1½ tsp.; the amount of active dried yeast is ¼ oz; the amount of water is 1 cup with 4 tbsps of molasses added; and ½ cup of walnuts and ½ cup or raisins are kneaded into the dough at step (e).

6. A loaf of garlic cheddar bread prepared by the process of claim 1 wherein the flour comprises 1 cup of unbleached unbromated white bread flour and 2 cups of stone ground whole wheat flour, with 1 cup of unbleached unbromated white bread flour and 1½ cups of stone ground whole wheat flour added in step (a) and ½ cup of whole wheat bread flour added in step (b); the amount of salt is 1½ tsp.; the amount of active dried yeast is ¼ oz; the amount of water is 1 cup with 1 tbsp. of honey and 2 cloves of garlic, minced, added; and 3 oz of cubed sharp cheddar cheese is kneaded into the dough at step (e).

7. A loaf of honey white bread prepared by the process of claim 1 wherein the flour comprises 3¼ cups of unbleached unbromated white bread flour; the amount of salt is 1½ tsp.; the amount of active dried yeast is ¼ oz; the amount of water is 1 cup with 2 tbsp. of honey added.

8. A process for making at least one loaf of bread without milk, butter, eggs or sucrose sugar, said process comprising the steps of:
(a) combining, in a mixing vessel, flour, salt, and rapidrise yeast;
(b) stirring very warm water, preferably between 120-130° F., into dry ingredients and optionally adding remaining flour to make soft dough;
(c) beating the dough until dough pulls away from sides of vessel and then continue beating for a few, preferably 3-4, minutes longer;
(d) placing the dough on a floured surface, covering and letting it rest for 10 minutes;
(e) kneading the dough for 4-5 minutes until soft and elastic;
(f) shaping the dough into a ball;
(g) placing the dough in a greased baking dish, preferably, 8″ diameter×4½″ deep;
(h) covering and letting it rise in a warm, draft-free place for less than an hour, preferably between 30 to 50 minutes, more preferably 40 minutes or until doubled in size;
(i) oven baking preferably at 375° F., until done, preferably between 45-50 minutes; and
(j) removing from oven and letting cool.

9. A loaf of honey whole wheat bread prepared by the process in claim 8 wherein the flour is 2½ cups of stone ground whole wheat flour, with 1½ cups added in step (a) and 1 cup added in step (b) and 1 cup of unbleached unbromated white bread flour added in step (b); the salt is 1¼ tsp.; the amount of rapidrise yeast is ¼ oz; the amount of water is 1½ cups with 2½ tbsp. of honey added.

10. A loaf of cinnamon swirl bread prepared by the process of claim 8 wherein the flour comprises 3½ cups of unbleached, unbromated white bread flour, with 1½ cups added in step (a) and 2 cups added in step (b); the amount of salt is 1½ tsp.; the amount of rapidrise dried yeast is ¼ oz; the amount of water is 1½ cups with 3 tbsp. of honey added; the process also including the additional steps: after step (e) and prior to step (f),
(e¹) heating 1 tbsp of honey until warm and adding 4 tbsp of ground cinnamon to the honey and mixing well;
(e²) rolling the dough out into a rectangle, preferably 12″×7″;
(e³) spreading the honey—cinnamon mixture out evenly on the rolled out dough; then,
(e⁴) beginning at the short end, rolling up the dough, jelly-roll style, and
(e⁵) pinching all seams and ends to seal.

11. A loaf of rye bread prepared by the process of claim 8 wherein the flour is 2½ cups of unbleached, unbromated white bread flour and 1 cup of rye flour, with 1½ cups of unbleached, unbromated white bread flour and 1 cup of rye flour, added in step (a) and 1 cup of unbleached unbromated white bread flour added in step (b); with 1 tbsp. of caraway seeds added in step (a); the amount of salt is 1½ tsp.; the amount of rapidrise yeast is ¼ oz; the amount of water is 1½ cups with 1½ tbsps. of honey added.

12. A loaf of cinnamon raisin walnut bread prepared by the process of claim 8 wherein the flour comprises 2½ cups of unbleached unbromated white bread flour and 1 cup of stone ground whole wheat flour, with 1½ cups of unbleached unbromated white bread flour and 1 cup of stone ground whole wheat flour added in step (a) and 1 cup of unbleached unbromated white bread flour added in step (b); with 3 tbsp. of cinnamon added in step (a); the amount of salt is 1½ tsp.; the amount of rapidrise dried yeast is ¼ oz; the amount of water is 1½ cups with 2 tbsps of molasses and 3 tbsps of honey added; and 1 cup of walnuts and ½ cup or raisins are kneaded into the dough at step (e).

13. A loaf of garlic cheddar bread prepared by the process of claim 8 wherein the flour comprises 2 cups of unbleached unbromated white bread flour and 1½ cups of stone ground whole wheat flour, with 2 cups of unbleached unbromated white bread flour and 1½ cups of stone ground whole wheat flour added in step (a); the amount of salt is 1½ tsp.; the amount of rapidrise dried yeast is ¼ oz; the amount of water is 1½ cups with 1½ tbsp. honey and 2 tsps of garlic, minced, added; and 3 oz of cubed sharp cheddar cheese is kneaded into the dough at step (e).

14. A loaf of honey white bread prepared by the process of claim 8 wherein the flour comprises 3½ cups of unbleached unbromated white bread flour, with 1½ cups of unbleached unbromated white bread flour added in step (a) and 2 cups of unbleached unbromated white bread flour added in step (b); the amount of salt is 1¼ tsp.; the amount of rapidrise dried yeast is ¼ oz; the amount of water is 1½ cups with 2 tbsp. of honey added.

15. A loaf of craisin orange bread prepared by the process of claim 8 wherein the flour comprises 2½ cups of unbleached unbromated white bread flour and 1 cup of stone ground whole wheat flour, with 1½ cups of unbleached unbromated white bread flour and 1 cup of stone ground whole wheat flour added in step (a) and 1 cup of unbleached unbromated white bread flour added in step (b); with 1½ tbsps. of orange zest and ½ cup of craisins added in step (b); the amount of salt is 1¼ tsp.; the amount of rapidrise dried yeast is ¼ oz; the amount of water is 1½ cups with 3 tbsps of honey added.
